(19) United States
(12) Patent Application Publication
(10) Pub. No.: US 2023/0163435 A1
(43) Pub. Date: May 25, 2023

(54) ELECTRICAL CONNECTION COVER

(71) Applicant: Polestar Performance AB, Göteborg (SE)

(72) Inventor: Johan Janers, Göteborg (SE)

(21) Appl. No.: 17/534,118

(22) Filed: Nov. 23, 2021

(51) Int. Cl. H01M 50/591; B60K 1/04; H01M 50/543; H01M 50/204; H01M 50/502

(52) U.S. Cl. CPC H01M 50/591; B60K 1/04; H01M 50/543; H01M 50/204; H01M 50/502; B60K 2001/0438

(57) ABSTRACT

An electrical connection cover operably coupleable to a supporting surface defining an electrical isolation wall and protruding boss, the electrical connection cover configured to conceal a first and second terminal and of a battery bus bar, including a body defining a lip at least partially surrounding a recess, the recess shaped and sized to enable the first and second terminal end of the battery bus bar to be positioned therein, wherein a portion of the body further defines a hollow ring including the wall defining interior surface shaped and sized to at least partially surround the boss of the supporting surface, and one or more notches configured to matingly receive a portion of the electrical isolation wall.

### TECHNICAL FIELD

The present disclosure relates generally to batteries for electric vehicles, and more particularly to an electrical connection cover configured to conceal and protect a respective positive and negative electrical terminal with a single fastener.

### BACKGROUND

Electric vehicles are becoming increasingly popular as consumers look to decrease their environmental impact and improve air quality. Instead of a traditional internal combustion engine, electric vehicles include one or more motors, powered by a rechargeable battery pack. Conventional electric vehicle battery packs are typically constructed of multiple components, including a plurality of battery modules, electrical current transmission systems, temperature control systems, safety systems, battery management systems, and one or more structural supports.

Conventional construction techniques begin with an empty battery tray, which represents a bottom and typically one or more sides of a structural vessel, representing a compartment, configured to contain the other components of the battery pack. Often the battery tray includes one or more structural supports (e.g., cross members, etc.), providing structural support to the battery pack, as well as surfaces within the battery tray compartment on which other components of the battery pack can be affixed. The various components, including the temperature control system (e.g., cooling panels, etc.) and plurality of battery modules can be positioned within the compartment and secured in place. Electrical current transmission systems, battery management systems, and safety systems are also positioned within the compartment. A lid or cover is then positioned on the battery tray, thereby sealing the compartment.

As typical voltages within a rechargeable battery pack often exceed 200 V, special attention must be paid to electrically isolating exposed positive and negative battery terminals or connection points within the battery tray. Improperly isolated battery terminals can result in arcing or other short between the terminals, which can in turn result in rapid discharge of electrical potential, thermal runaway, fire, etc. Although the various efforts have been made over the years to improve the electrical connection covers, further improvements are always desired. The present disclosure addresses this concern.

### SUMMARY OF THE DISCLOSURE

Embodiments of the present disclosure provide an electrical terminal cover which can be used in connection with a battery disconnect unit or other component within a rechargeable electric vehicle battery pack to conceal a first and a second terminal end (e.g., anode and cathode) of a battery bus bar. In some embodiments, a bottom portion of the electrical terminal cover includes an extended ring having a pair of keyholes or notches configured to enable the passage of a wall therethrough, thereby advantageously enabling the electrical terminal cover to be secured by a single fastener in a manner that inhibits rotation and translation of the terminal cover relative to the terminals.

One embodiment of the present disclosure provides electrical connection cover operably coupleable to a supporting surface defining an electrical isolation wall and protruding boss, the electrical connection cover configured to conceal a first and second terminal and of a battery bus bar, the electrical connection including a body defining a lip at least partially surrounding a recess, the recess shaped and sized to enable the first and second terminal end of the battery bus bar to be positioned therein, wherein a portion of the body further defines a hollow ring including the wall defining interior surface shaped and sized to at least partially surround the boss of the supporting surface, and one or more notches configured to matingly receive a portion of the electrical isolation wall.

In one embodiment, the body is a unitary member. In one embodiment, the body is constructed of an insulative material. In one embodiment, the electrical connection cover further includes a fastener configured to enable coupling of the electrical connection cover to the supporting surface. In one embodiment, the fastener includes an integrated washer. In one embodiment, the fastener is configured to reside within a countersunk pocket to minimize the outward protrusion of a top surface of the fastener from a top surface of the body of the electrical connection cover. In one embodiment, the electrical connection cover further includes a compression limiter configured to compression support to the body. In one embodiment, the lip defines one or more steps to promote a conformed fit between the electrical connection cover and the supporting surface. In one embodiment, the electrical connection cover further includes a protruding wall extending outwardly from a planar surface of the lip to promote a conformed fit between the electrical connection cover and the supporting surface.

Another embodiment of the present disclosure provides an electrical connection cover system, including an electrical component mountable within an electric vehicle battery tray, the electrical component configured to receive a first and second terminal and of a battery bus bar, the electrical component having a supporting surface defining an electrical isolation wall and a protruding boss positioned between the first and second terminal, and an electrical connection cover including a body defining a lip at least partially surrounding a recess, the recess shaped and sized to enable the first and second terminal end of the battery bus bar to be positioned therein, wherein a portion of the body further defines a hollow ring including the wall defining interior surface shaped and sized to at least partially surround the boss of the electrical component, and one or more notches configured to matingly receive a portion of the electrical isolation wall Yet another embodiment of the present disclosure provides an electrical connection cover operably coupleable to a supporting surface defining an electrical isolation wall and protruding boss, the electrical connection cover configured to conceal a first and second terminal and of a battery bus bar, the electrical connection including a unitary body defining a lip at least partially surrounding a recess, the recess shaped and sized to enable the first and second terminal end of the battery bus bar to be positioned therein, wherein a portion of the unitary body is constructed of an insulative material, and further defines a hollow ring including the wall defining interior surface shaped and sized to at least partially surround the boss of the supporting surface, and one or more notches configured to matingly receive a portion of the electrical isolation wall wherein the lip defines one or more steps and a protruding wall extending outwardly from a planar surface of the lip to promote a conformed fit between the electrical connection cover and the supporting surface; a fastener including an integrated washer configured to enable coupling of the electrical connection cover to the supporting surface, wherein the fastener is configured to reside within a countersunk pocket to minimize the outward protrusion of a top surface of the fastener from a top surface of the body of the electrical connection cover; and a compression limiter operably coupled to the unitary body configured to compression support to the body.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is an exploded, perspective view depicting an electric vehicle including a multi-cell battery pack, in accordance with an embodiment of the disclosure.

FIG. 2 is a perspective view depicting a multi-cell battery pack, in accordance with an embodiment of the disclosure.

FIG. 3 is a top perspective view depicting a first and second terminal ends of a battery bus bar mounted to a battery disconnect unit, in accordance with an embodiment of the disclosure.

FIG. 4 is a perspective view depicting electrical connection cover configured to conceal the first and second terminal ends of the battery bus bar of FIG. 3, in accordance with an embodiment of the disclosure.

FIG. 5 is a top perspective view depicting a electrical connection cover, in accordance with an embodiment of the disclosure.

FIG. 6 is a bottom perspective view depicting the electrical connection cover of FIG. 5, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

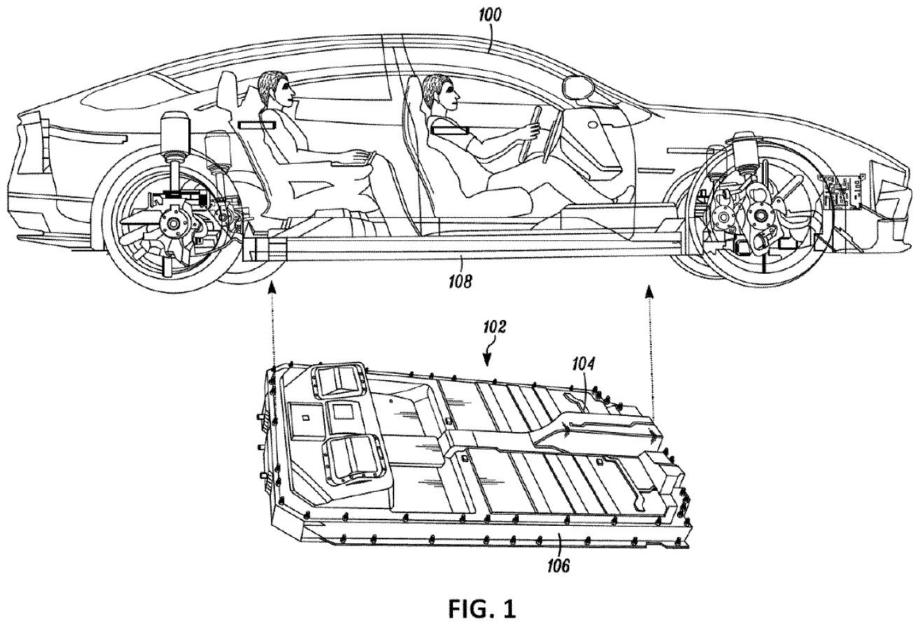

Referring to FIG. 1, an electric vehicle 100 comprising a multi-cell electric vehicle battery pack 102 is depicted in accordance with an embodiment of the disclosure. In some embodiments, the battery pack 102 can include a cover 104 operably coupled to a battery tray 106, thereby creating a sealed battery cell compartment containing clusters of individual battery cells and other battery related components. The assembled battery pack 102 can then be mounted to the frame and/or chassis of the vehicle 100, which in some embodiments can be positioned adjacent to a cabin floor 108 of the vehicle 100, thereby maintaining a low center of gravity.

Various embodiments of the present disclosure will be described in detail with reference to the drawings, wherein like reference numerals represent like parts and assemblies throughout the several views. Various directions and orientations, such as “upward,” “downward,” “top,” “bottom,” “upper,” “lower”, etc. are generally described herein with reference to the drawings in the usual gravitational frame of reference, regardless of how the components may be oriented during assembly.

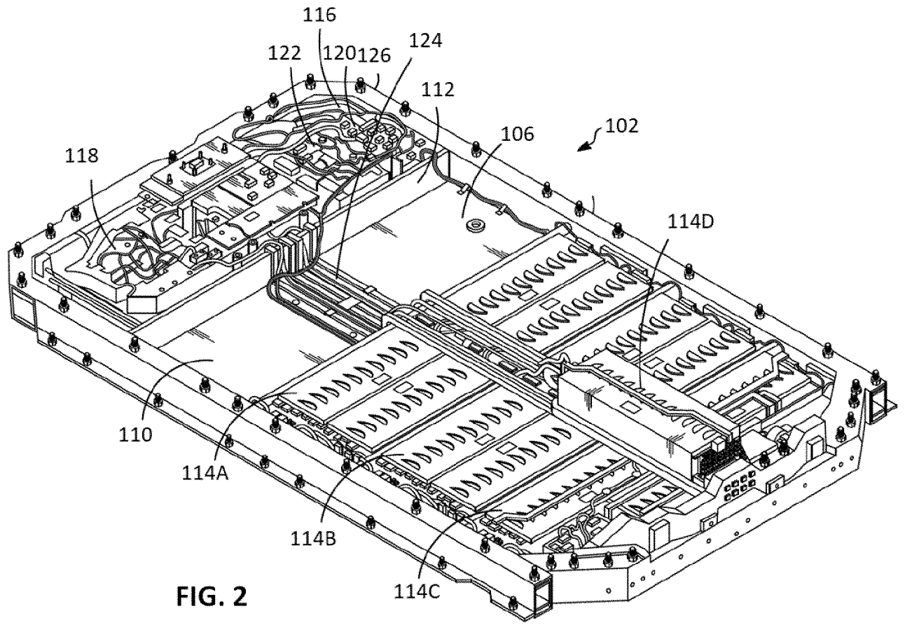

With additional reference to FIG. 2, an exploded, perspective of a multi-cell electric vehicle battery pack 102 is depicted in accordance with an embodiment of the disclosure. As depicted, the battery pack 102 can include a battery tray 106, defining a battery cell compartment containing individual battery cells and other battery related components. For example, in one embodiment, the battery tray 106 can represent a bottom and one or more sides of a structural vessel defining a compartment 110. Further, in embodiments, the battery tray 106 can include one or more structural supports, such as cross members 112, which can provide structural support to the battery pack 102, as well as surfaces within the compartment 110 which other components of the battery pack can be affixed.

In some embodiments, individual battery cells can be grouped into a number of distinct clusters sometimes referred to as battery modules 114. In some embodiments, the battery pack 102 can include a plurality of battery modules 114A-D; although the grouping of the individual cells into other quantities of clusters of varying shapes and sizes other than that depicted in FIG. 2 is also contemplated.

In addition to the modules 114, the battery pack 102 can include a variety of other electrical components. For example, in one embodiment, the components can include a battery management system 116 (including current management systems), a battery disconnect unit 118, an electrical current transmission system 120, one or more safety systems 122, and a battery bus bar 124 interconnecting the various components 114A-D, 116, 118, 120, and 122. Once the components have been positioned within the compartment 110, the cover 104 (as depicted in FIG. 1) can be affixed to the top surface 126 of the battery tray 106 via a plurality of fasteners, adhesive, or a combination thereof.

It should be understood that the terms “battery,” “cell,” and “battery cell” may be used interchangeably and may refer to any of a variety of different cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing or tray, the individual battery cells electrically interconnected to achieve the desired voltage and capacity for a particular application.

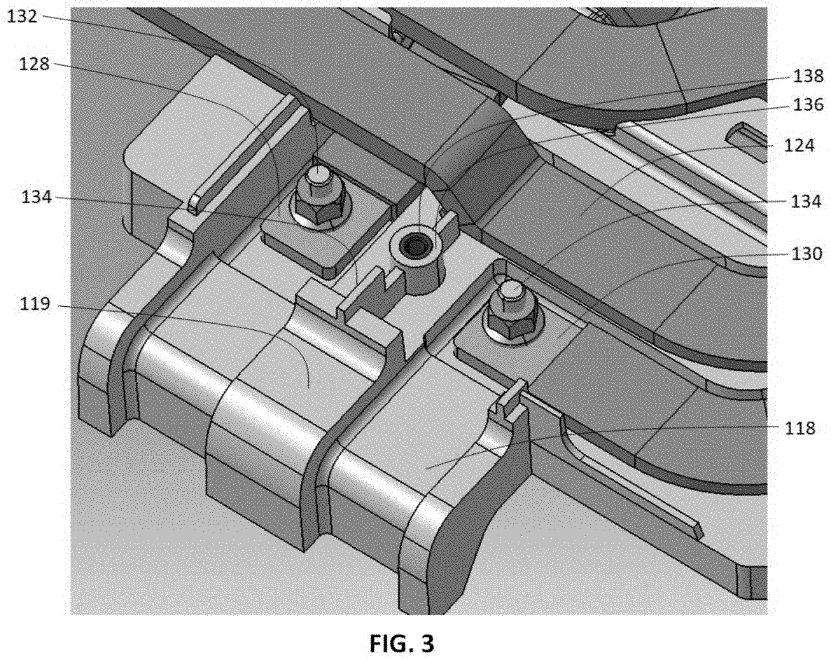

Additional reference to FIG. 3, the terminal ends 128, 130 of a battery bus bar 124, for example, as mounted to a battery disconnect unit 118, is depicted in accordance with an embodiment of the disclosure. As depicted, in some embodiments, the terminal ends 128, 130 can operably couple respective portions of the battery bus bar 124 to the battery disconnect unit (BDU) 118 via one or more electrically conductive threaded connectors 132, 134. For example, in one embodiment, an electrically conductive threaded rod, bolt or other fastener can protrude from the BDU 118, thereafter the terminal ends 128, 130, each defining an aperture, can be positioned over the threaded rod, bolt or other fastener and held in position with a nut, thereby electrically coupling the respective terminal ends 128, 130 of the battery bus bar 124 to relevant portions of the BDU 118.

In embodiments, the BDU 118, which is common across all rechargeable electric vehicle systems, can include a main fuse for the battery bus bar 124, as well as optional switching relays and a manual service disconnect. As depicted, in some embodiments, the BDU 118 can include a supporting surface 119 defining an electrical isolation wall 134 (sometimes referred to as a “rib”) positioned between the respective electrically conductive threaded connectors 132, 134. The electrical isolation wall 134, which can be constructed of a insulative (e.g., non-electrically conductive) material, can generally serve to inhibit arcing or the formation of other electrical paths between the terminal ends 128, 130 of the battery bus bar 124, thereby reducing the likelihood of a short occurring between the terminal ends 128, 130. Further, in some embodiments, the electrical isolation wall 134 can include a boss 136 or other protruding feature, which can define an aperture 138. For example, in one embodiment, the aperture can be a threaded insert. In some embodiments, the threaded insert can have a standard size (e.g., M2, M3, M4, M5, etc.); although the use of other sizes of threaded inserts is also contemplated.

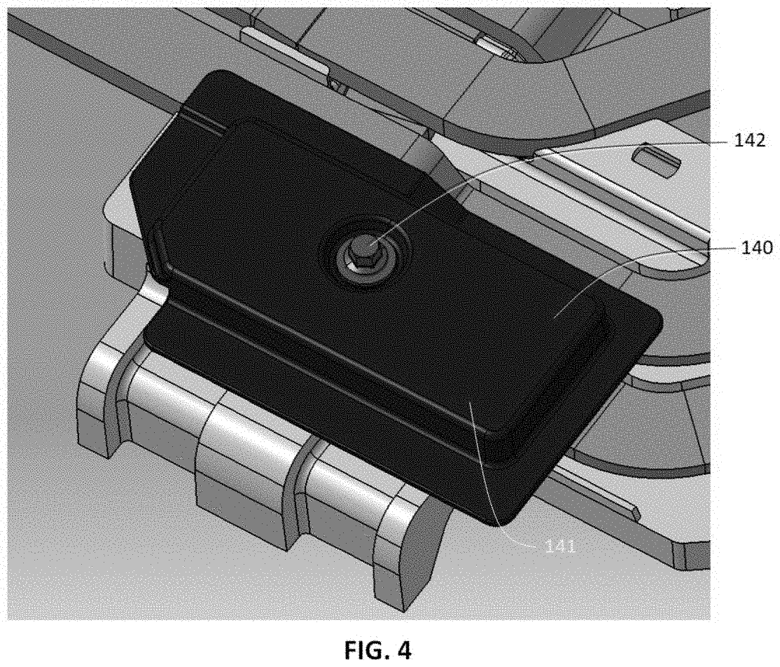

Although the isolation wall 134 serves its purpose well in inhibiting arcing or the formation of other electrical paths between the terminal ends 128, 130 of the battery bus bar 124 further protective measures are desirable. With additional reference to FIG. 4, a terminal cover 140 configured to conceal and electrically isolate the terminal ends 128, 130 of the battery bus bar 124 is depicted in accordance with an embodiment of the disclosure. In some embodiments, the terminal cover 140 can be unitary member constructed of an insulative (e.g., non-electrically conductive) material, such as plastic or the like, and can be configured to operably couple to the BDU 118 (or other battery pack component) via a single fastener 142, thereby reducing the overall number of parts or components within the battery pack 102, as well as easing efforts in the assembly or construction of the battery pack 102.

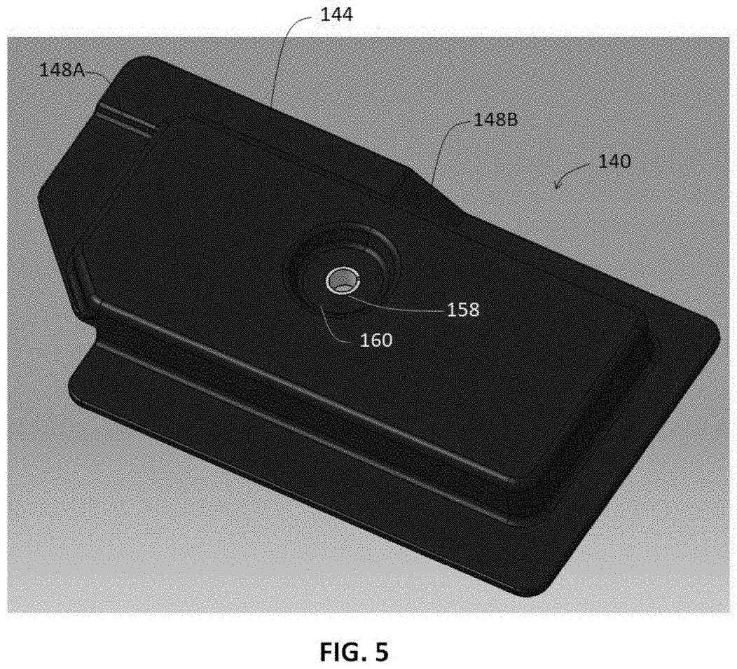

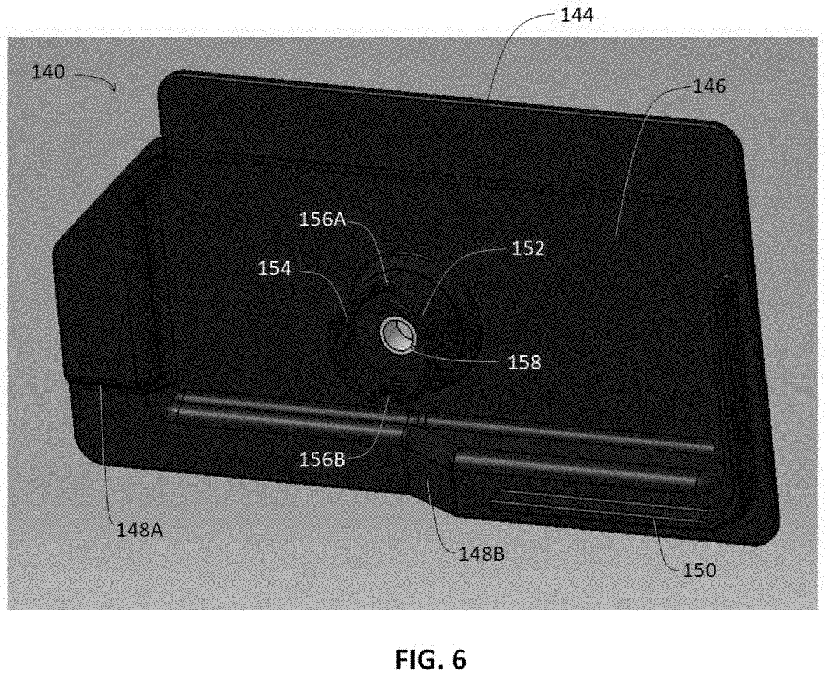

With additional reference to FIGS. 5 and 6, respective top and bottom perspective views of the terminal cover 140 are depicted in accordance with an embodiment of the disclosure. In some embodiments, the terminal cover 140 can include a unitary body 141 defining a lip 144 at least partially surrounding a recess 146 shaped and sized to enable the electrically conductive threaded connectors 132, 134 (and respective portions of the terminal ends 128, 130) to be positioned therein.

In some embodiments, the lip 144 can represent a substantially planar surface at least partially surrounding or circumscribing the recess 146, which can be configured to at least partially contact an upper surface of the BDU 118 (or other battery pack component), thereby creating at least a partial steel around the recess 148 to inhibit the intrusion of water or other fluid creating the potential for the formation of an electrically conductive path between the terminal ends 128, 130. In some embodiments, the lip 144 may include one or more steps 148A-B to promote a more conformed fit between the lip 144 and the upper surface of the BDU 118 (or other battery pack component). Further, in some embodiments, the lip 144 can define a protruding wall 150 which can extend from the lip 144 to promote a better fit between the upper surface of the BDU 118 (or other battery pack component) and a planar surface of the lip 144. For example, in some embodiments, the protruding wall 150 can extend into a corresponding recess defined in the BDU 118. In other embodiments, the protruding wall 150 can extend outwardly from the planar surface of the lip 144 to contact an upper surface of the BDU 118 to inhibit the intrusion of water or other fluid to the recess 144.

As further depicted in FIG. 6, the recess 146 can define a hollow ring 152, which in some embodiments can extend outwardly from a planar surface of the recess 146. In some embodiments, the hollow ring 152 can include a wall 154 defining an interior surface shaped and sized to at least partially surround the boss 136 defined by the electrical isolation wall 134 of the BDU 118 (or other battery pack component). Further, in some embodiments, the wall 154 can define one or more keyholes or notches 156A-B configured to mate with a portion of the electrical isolation wall 134 of the BDU 118.

Thereafter, the terminal cover 140 can be secured in position relative to the BDU 118 with a single fastener 142, for example, a bolt or other threaded fastener, which in some embodiments can include an integrated washer. To inhibit over compression of the terminal cover 140, in some embodiments, the terminal cover 140 can include a compression limiter 158 configured to provide and maintain joint integrity of a plastic assembly. In some embodiments, the fastener 142 can be configured to reside within a pocket 160 defined by the recess 146, thereby enabling a top surface of the fastener 142 to be substantially flush with (or at least minimize the outward protrusion from) a top surface of the terminal cover 140. Accordingly, embodiments of the present disclosure advantageously enable the terminal cover 142 be secured to components within the battery pack 102 to shield the terminal ends 128, 130 of the battery bus bar 124 by a single fastener 142 in a manner and then inhabits rotation and translation of the terminal cover 140 relative to the terminal ends 128, 130.

The invention is further illustrated by the following embodiments:

An electrical connection cover, comprising: a supporting surface defining an electrical isolation wall and protruding boss; and a cover body defining a lip at least partially surrounding a recess, the recess shaped and sized to enable the first and second terminal end of the battery bus bar to be positioned therein, wherein a portion of the cover body further defines a hollow ring including the wall defining interior surface shaped and sized to at least partially surround the boss of the supporting surface, and one or more notches configured to matingly receive a portion of the electrical isolation wall, enabling the electrical connection cover to conceal a first terminal end and second terminal end of a battery bus bar.

A system or method according to any embodiment, wherein the cover body is a unitary member.

A system or method according to any embodiment, wherein the cover body is constructed of an insulative material.

A system or method according to any embodiment, further comprising a fastener configured to enable coupling of the cover body to the supporting surface.

A system or method according to any embodiment, wherein the fastener includes an integrated washer.

A system or method according to any embodiment, wherein the fastener is configured to reside within a countersunk pocket to minimize the outward protrusion of a top surface of the fastener from a top surface of the body of the cover body.

A system or method according to any embodiment, further comprising a compression limiter configured to compression support to the cover body.

A system or method according to any embodiment, wherein the lip defines one or more steps to promote a conformed fit between the cover body and the supporting surface.

A system or method according to any embodiment, further defining a protruding wall extending outwardly from a planar surface of the lip to promote a conformed fit between the cover body and the supporting surface.

An electric vehicle comprising the electrical connection cover according to any embodiment of the disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An electrical connection cover, comprising:
a supporting surface defining an electrical isolation wall and protruding boss; and
a cover body defining a lip at least partially surrounding a recess, the recess shaped and sized to enable the first and second terminal end of the battery bus bar to be positioned therein, wherein a portion of the cover body further defines a hollow ring including the wall defining interior surface shaped and sized to at least partially surround the boss of the supporting surface, and one or more notches configured to matingly receive a portion of the electrical isolation wall, enabling the electrical connection cover to conceal a first terminal end and second terminal end of a battery bus bar.

2. The electrical connection cover of claim 1, wherein the cover body is a unitary member.

3. The electrical connection cover of claim 1, wherein the cover body is constructed of an insulative material.

4. The electrical connection cover of claim 1, further comprising a fastener configured to enable coupling of the cover body to the supporting surface.

5. The electrical connection cover of claim 4, wherein the fastener includes an integrated washer.

6. The electrical connection cover of claim 4, wherein the fastener is configured to reside within a countersunk pocket to minimize the outward protrusion of a top surface of the fastener from a top surface of the cover body.

7. The electrical connection cover of claim 1, further comprising a compression limiter configured to compression support to the cover body.

8. The electrical connection cover of claim 1, wherein the lip defines one or more steps to promote a conformed fit between the cover body and the supporting surface.

9. The electrical connection cover of claim 1, further defining a protruding wall extending outwardly from a planar surface of the lip to promote a conformed fit between the cover body and the supporting surface.

10. An electrical connection cover system, comprising:
an electrical component mountable within an electric vehicle battery tray, the electrical component configured to receive a first and second terminal and of a battery bus bar, the electrical component having a supporting surface defining an electrical isolation wall and a protruding boss positioned between the first and second terminal;
an electrical connection cover including a body defining a lip at least partially surrounding a recess, the recess shaped and sized to enable the first and second terminal end of the battery bus bar to be positioned therein, wherein a portion of the body further defines a hollow ring including the wall defining interior surface shaped and sized to at least partially surround the boss of the electrical component, and one or more notches configured to matingly receive a portion of the electrical isolation wall

11. The electrical connection cover system of claim 10, wherein the electrical component is a battery disconnect unit.

12. The electrical connection cover system of claim 10, wherein the body is a unitary member.

13. The electrical connection cover system of claim 10, wherein the body is constructed of an insulative material.

14. The electrical connection cover system of claim 10, further comprising a fastener configured to enable coupling of the electrical connection cover to the supporting surface.

15. The electrical connection cover system of claim 14, wherein the fastener includes an integrated washer.

16. The electrical connection cover system of claim 14, wherein the fastener is configured to reside within a countersunk pocket to minimize the outward protrusion of a top surface of the fastener from a top surface of the body of the electrical connection cover.

17. The electrical connection cover system of claim 10, further comprising a compression limiter configured to compression support to the body.

18. The electrical connection cover system of claim 10, wherein the lip defines one or more steps to promote a conformed fit between the electrical connection cover and the supporting surface.

19. The electrical connection cover system of claim 10, further defining a protruding wall extending outwardly from a planar surface of the lip to promote a conformed fit between the electrical connection cover and the supporting surface.

20. An electrical connection cover operably coupleable to a supporting surface defining an electrical isolation wall and protruding boss, the electrical connection cover configured to conceal a first and second terminal and of a battery bus bar, the electrical connection comprising:
a unitary body defining a lip at least partially surrounding a recess, the recess shaped and sized to enable the first and second terminal end of the battery bus bar to be positioned therein, wherein a portion of the unitary body is constructed of an insulative material, and further defines a hollow ring including the wall defining interior surface shaped and sized to at least partially surround the boss of the supporting surface, and one or more notches configured to matingly receive a portion of the electrical isolation wall wherein the lip defines one or more steps and a protruding wall extending outwardly from a planar surface of the lip to promote a conformed fit between the electrical connection cover and the supporting surface;
a fastener including an integrated washer configured to enable coupling of the electrical connection cover to the supporting surface, wherein the fastener is configured to reside within a countersunk pocket to minimize the outward protrusion of a top surface of the fastener from a top surface of the body of the electrical connection cover; and
a compression limiter operably coupled to the unitary body configured to compression support to the body.
